(19) United States
(12) Patent Application Publication
(10) Pub. No.: US 2006/0228925 A1
(43) Pub. Date: Oct. 12, 2006

(54) Power cord arranging device for a vacuum cleaner

(75) Inventor: Joung-soo Park, Jeonju-si (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 11/289,486

(22) Filed: Nov. 30, 2005

(30) Foreign Application Priority Data
Apr. 11, 2005 (KR) 2005-29814

(51) Int. Cl. H01R 4/60

(52) U.S. Cl. 439/191

(57) ABSTRACT

A power cord arranging device for powered equipment, for example a vacuum cleaner, includes in one embodiment a main holder with a first finger insertion part for receiving all fingers except a thumb of a user's hand and bent at an angle, a plurality of guide rollers provided at a corner formed by the bent portion of the main holder to guide the power cord, a pressing holder connected with the main holder by a connection member and including a second finger insertion part for receiving a user's thumb, and at least one second guide roller formed on the pressing holder to correspond to the first guide rollers.

### CROSS-REFERENCE TO RELATED APPLICATIONS

This application discloses subject matter that may be related to the subject matter disclosed in U.S. patent application Ser. No. 11/258,180 filed Oct. 26, 2005 (116511-00173), claiming priority of Korean Patent Application 2005-30615, filed Apr. 13, 2005.

This application claims benefit under 35 U.S.C. § 119(a) of Korean Patent Application No. 2005-29814, filed Apr. 11, 2005, the entire contents of which are incorporated herein by reference.

### BACKGROUND OF THE INVENTION

1. Field of the Invention

The present invention relates generally to the field of equipment powered by a power cord. In more specific exemplary embodiments, a power cord arranging device is disclosed that is particularly useful, for example, in vacuum cleaners.

2. Description of the Related Art

In general, vacuum cleaners can be divided into a canister-type vacuum cleaner and an upright-type vacuum cleaner.

The canister-type vacuum cleaner comprises a cord reel assembly for stowing a power cord as being wound thereon inside a cleaner body. However, since the upright-type vacuum cleaner requires a relatively longer power cord, the upright-type vacuum cleaner uses a cord holder, instead of the cord reel assembly. The power cord can be wound onto the cord holder on the outside of the cleaner body.

In this case, a user has to grab and wind the power cord on the cord holder in person. During this, however, the power cord would be dragged on a surface being cleaned, thereby being contaminated by impurities and dust. As a result, the user's hand may also be contaminated while grabbing and winding the power cord. Furthermore, when the user winds the power cord hastily with the power cord in his/her hand, frictional heat generated between the power cord and the user's hand may hurt the user's hand.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In an exemplary embodiment, a power cord arranging device enables a user to safely arrange a power cord on a cord holder without concern about being contaminated by impurities or hurt by frictional heat.

The invention will be disclosed in terms of several exemplary embodiments, which will be described in terms of application to a vacuum cleaner, which is one useful application of the invention. Those skilled in the art will appreciate that the devices disclosed herein may also be useful with many other appliances where a cord is to be stored. The present invention is therefore not intended to be limited to the field of vacuum cleaners, but can be applied to any kind of appliance or other equipment that uses a power cord.

In an exemplary embodiment, a power cord arranging device for a vacuum cleaner comprises a main holder which includes a first finger insertion part and a power cord guide, and a pressing holder which includes a second finger insertion part and a pressing guide for pressing the power cord put on the power cord guide.

In an embodiment, the first finger insertion part is formed in a size for receiving all fingers except a thumb of a hand, and the second finger insertion part is formed in a size for receiving the thumb.

In an embodiment, the main holder is bent by approximately 90° and the power cord guide is mounted on the bent portion.

The power cord guide comprises a first guide roller whereas the pressing guide may comprise a second guide roller corresponding to the first guide roller.

The power cord arranging device may comprise at least three first guide rollers. The first and the second guide rollers may have a diameter greater than that of the power cord.

In an embodiment, one of the main holder and the pressing holder includes a mounting recess and the other one includes a mounting projection, so that the main holder and the pressing holder are stored as engaged with each other through the mounting recess and the mounting projection.

The main holder and the pressing holder may be linked by a connection member. Preferably, the main holder and the pressing holder are made of plastic.

According to another embodiment of the present invention, there is provided a power cord arranging device for a vacuum cleaner, comprising a main holder including a first finger insertion part for receiving all fingers except a thumb of a user's hand and bent by approximately 90°, a plurality of guide rollers provided at a corner formed by the bent portion of the main holder to guide the a power cord of the vacuum cleaner, a pressing holder connected with the main holder by a connection member and including a second finger insertion part for receiving a user's thumb, and at least one second guide roller formed on the pressing holder to correspond to the first guide rollers.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a power cord arranging device for a vacuum cleaner, according to an embodiment of the present invention;

FIG. 2 is an exploded, perspective view of the power cord arranging device for a vacuum cleaner, according to an embodiment of the present invention; and

FIG. 3 is a view showing the power cord arranging device for a vacuum cleaner, according to an embodiment of the present invention, in use.

### DETAILED DESCRIPTION OF THE EXEMPLARY EMBODIMENTS

An improved cord handling device and features thereof will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, persons skilled in the art may effect such feature, structure, or characteristic in connection with other embodiments whether or not explicitly described.

In the following description, similar drawing reference numerals may be used for the same elements even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the exemplary features described with unnecessary detail.

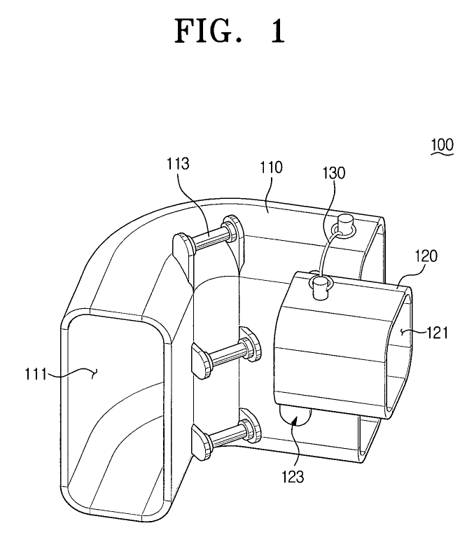

As shown in FIG. 1, a power cord arranging device 100 according to an example (exemplary) embodiment, comprises a main holder 110 and a pressing holder 120.

In the embodiment shown, the main holder 110 comprises a first finger insertion part 111 for receiving a user's fingers except a thumb and a bent part which is bent by approximately 90° to mount a power cord guide. The power cord guide comprises a first guide rollers 113. According to an embodiment of the present invention, three first guide rollers 113 are provided to the bent part of the main holder 110. Although not shown, the power cord guide may be configured as a groove having a predetermined depth to support the power cord. The power cord guide mounted on the main holder 110 can be implemented by any structure capable of reducing friction between the main holder 110 and the power cord.

The pressing holder 120 comprises a second finger insertion part 121 for receiving a user's thumb and a pressing guide for pressing the power cord put on the power cord guide. The pressing guide comprises a second guide roller 123 corresponding to one of the plurality of first guide rollers 113.

In an embodiment, length of the first and the second guide rollers 113 and 123 is greater than a diameter of the power cord.

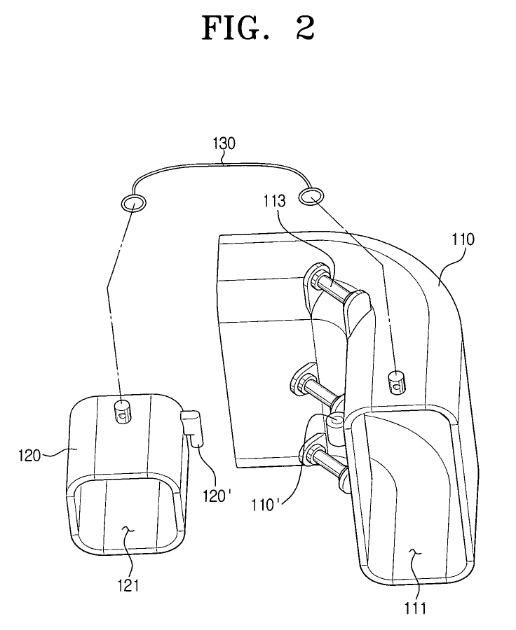

As shown in FIG. 2, in an embodiment the main holder 110 includes a mounting recess 110′ whereas the pressing holder 120 includes a mounting projection 120′. Therefore, the main holder 110 and the pressing holder 120 can be stored together by engaging the mounting recess 110′ and the mounting projection 120′ with each other. Positions of the mounting recess 110′ and the mounting projection 120′ may be exchanged.

In the embodiment shown, the main holder 110 and the pressing holder 120 are linked by a connection member 130 so as to prevent the pressing holder 120 from being lost during use. Also, the main holder 110 and the pressing holder 120 are made of plastic to protect the user's hand.

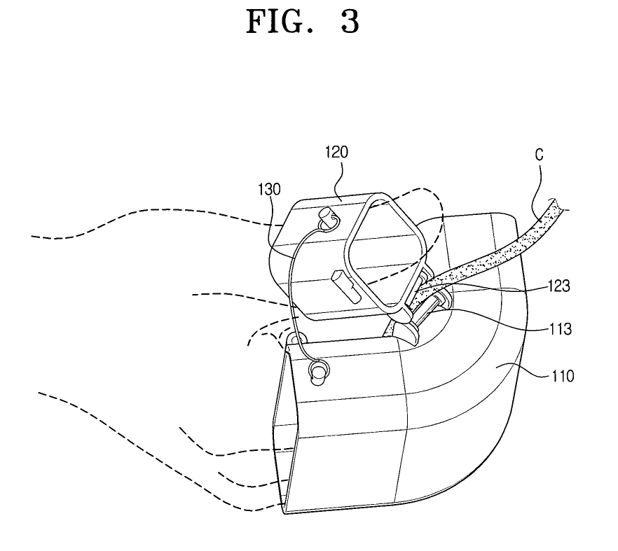

Hereinbelow, an example method of using the power cord arranging device will be described with reference to FIG. 3.

In an embodiment, when not in use, the power cord arranging device 100 is stowed in a predetermined storage space in the cleaner body. During the storage, the main holder 110 and the pressing holder 120 are engaged with each other. More specifically, as shown in FIG. 2, the power cord arranging device 100 is stored with the mounting recess 110′ formed on the main holder 100 and the mounting projection 120′ formed on the pressing holder 120 engaged with each other.

To use the upright-type vacuum cleaner, the user draws out the power cord C being wound on the outside of the vacuum cleaner and after the cleaning work, may wind the power cord C back on the cleaner body using the power cord arranging device 100 according to an exemplary embodiment.

More specifically, in this example the user takes out the power cord arranging device 100 from the predetermined storage space and releases engagement between the main holder 110 and the pressing holder 120. Since the connection member 130 links the main holder 110 and the pressing holder 120, the pressing holder 120 would not be lost although the engagement between the main holder 110 and the pressing holder 120 are released.

Assuming that the user is right-handed, the user inserts his/her fingers except the thumb in the first finger insertion part 111 formed on the main holder 110 and the thumb in the second finger insertion part 121 (FIG. 2) formed on the pressing holder 120, thereby putting on the power cord arranging device 100 like a mitten. Because the main holder 110 is bent by approximately 90°, the user can comfortably grab the power cord C.

As the user puts on the main holder 110 and the pressing holder 120 like a mitten and holds the power cord C as shown in FIG. 3, the power cord C is disposed between the first guide roller 113 formed on an upper part of the main holder 110 and the second guide roller 123 formed on the pressing holder 120. When the user winds the power cord C, pressing the power cord C with the second guide roller 123 formed on the pressing holder 120 by the thumb, the first and the second guide rollers 113 and 123 are rotated respectively in the opposite directions and accordingly, the main holder 110 and the pressing holder 120 are prevented from directly rubbing the power cord C.

By using the power cord arranging device 100 according to an embodiment of the present invention, even if the user winds the power cord C rapidly, the power cord C, being guided between the first and the second guide rollers 113 and 123, does not directly contact the user's hand. Therefore, the user's hand can be prevented from being contaminated by impurities attached on the power cord C or getting burned by frictional heat generated between the user's hand and the power cord C.

As can be appreciated from the above description, according to an embodiment of the present invention, the user can safely and conveniently arrange the power cord C without concerning about being contaminated by impurities and hurt by frictional heat.

While the invention has been shown and described with reference to certain embodiments thereof, it will be understood by those skilled in the art that various changes in form and details may be made therein without departing from the spirit and scope of the invention as defined by the appended claims.

What is claimed is:

1. A power cord arranging device, comprising:
a main holder which includes a first finger insertion part and a power cord guide; and
a pressing holder which includes a second finger insertion part and a pressing guide for pressing the power cord placed on the power cord guide.

2. The power cord arranging device of claim 1, wherein
the first finger insertion part is formed in a size for receiving all fingers except a thumb of a hand, and
the second finger insertion part is formed in a size for receiving the thumb.

3. The power cord arranging device of claim 1, wherein the main holder has an angled portion angled approximately 90° and the power cord guide is mounted on the angled portion.

4. The power cord arranging device of claim 2, wherein the main holder has an angled portion angled approximately 90° and the power cord guide is mounted on the angled portion.

5. The power cord arranging device of claim 4, wherein the power cord guide comprises a first guide roller.

6. The power cord arranging device of claim 5, comprising at least three first guide rollers.

7. The power cord arranging device of claim 5, wherein the pressing guide comprises a second guide roller which corresponds to the first guide roller.

8. The power cord arranging device of claim 7, wherein one of the main holder and the pressing holder includes a mounting recess and the other one includes a mounting projection, so that the main holder and the pressing holder are stored as engaged with each other through the mounting recess and the mounting projection.

9. The power cord arranging device of claim 7, wherein the main holder and the pressing holder are linked by a connection member.

10. The power cord arranging device of claim 7, wherein the first and the second guide rollers have a diameter greater than that of the power cord.

11. The power cord arranging device of claim 7, wherein the main holder and the pressing holder are made of plastic.

12. A power cord arranging device, comprising:
a main holder including a first finger insertion part for receiving all fingers except a thumb of a user's hand and having a bent portion with an angle of approximately 90°;
a plurality of guide rollers provided at a corner formed by the bent portion of the main holder to guide the a power cord;
a pressing holder connected with the main holder by a connection member and including a second finger insertion part for receiving a user's thumb; and
at least one second guide roller formed on the pressing holder to correspond to the first guide rollers.
